(19) United States
(12) Patent Application Publication
(10) Pub. No.: US 2003/0061756 A1
(43) Pub. Date: Apr. 3, 2003

(54) Fireant/insect gun

(76) Inventor: Billy C. Lokey, Houston, TX (US)

Correspondence Address: BILLY C. LOKEY, 19 CHISHOLM TRAIL DR., WIMBERLY, TX, 78676, US

(21) Appl. No.: 09/967,761

(22) Filed: Oct. 1, 2001

(51) Int. Cl. A01K 85/00; A01M 1/20; A01M 5/00

(52) U.S. Cl. 43/42.06

(57) ABSTRACT

THE GUN IS DESIGNED TO DROP POISON POWDER ON FIRE ANT/INSECT MOUNDS. THE BAIT OR POISON RESERVIOR (FIG. B) IS FILLED WITH POWDER, THEN REPLACE CAP. (FIG B) THE RESERVIOR SIZE IS 2″ ID. BY 24″ IN LENGTH, HOWEVER THE THE LENGTH CAN VARY IF NEEDED FOR HORSEBACK OR PICKUP TRUCK IN PASTURES. HOLD THE GUN BY THE GRIP (FIG C).

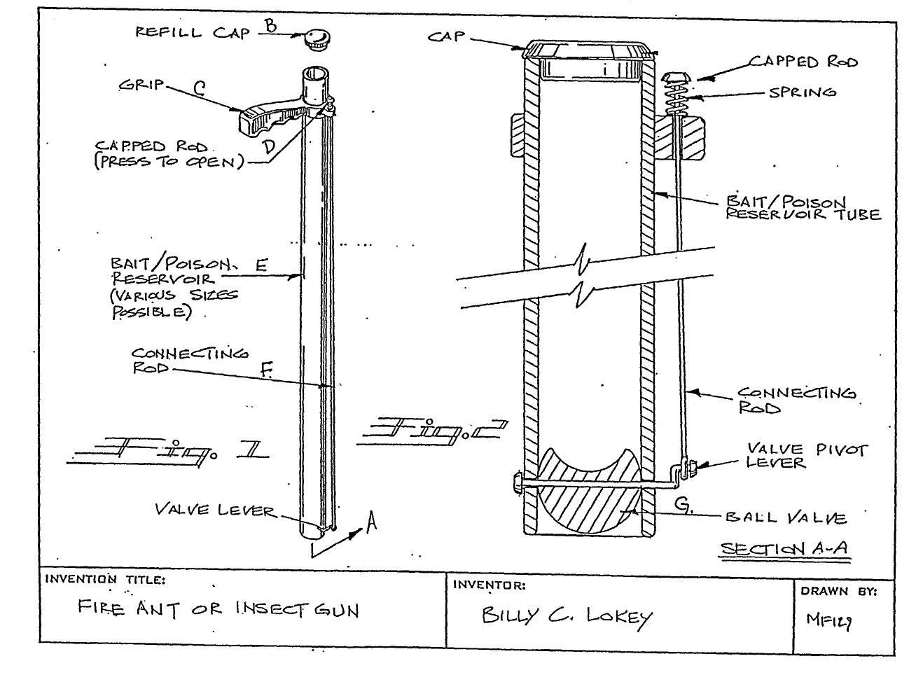

HOLD THE GUN OVER THE FIREANT/INSECT MOUND AND PUSH DOWN ON THE CAPPED ROD (FIG D). THE ROD WILL TURN THE LEVER (FIG A) TURNING THE BALL VALVE OVER (FIG G) RELEASING THE POWDER RELEASING THE CAPPED ROD WILL ALLOW THE BALL VALVE TO RETURN TO THE UPRIGHT POSITION AND REFILL.

A—VALVE LEVER

B—RESERVIOR CAP

C—GRIP

D—CAPPED ROD

E—BAIT/POISON RESERVIOR VARIOUS SIZES POSSIBLE.

F—CONNECTING ROD

G—BALL VALVE

THE FIREANT GUN IS A HOLLOW TUBE APPROIX. 24″ LONG WITH A 2″ INSIDE DIAMETER. A HANDLE IS ATTACHED TO GRIP THE GUN. THE TUBE HAS A CAP ON TOP. A CONNECTING ROD IS INSERTED THROUGH A HOLE IN THE HANDLE AND CONNECTED TO A LEVER AT THE BOTTOM OF THE TUBE. THE LEVER IS INSERTED THROUGH THE BOTTOM OF THE TUBE AND IS CONNECTED TO A BALL VALVE. THE TOP OF THE ROD HAS A SPRING AND A CAP. PUSH DOWN ON THE ROD THE LEVER WILL TURN BALL VALVE OVER. RELEASE THE ROD AND THE SPRING WILL RAISE THE ROD RETURNING THE BALL VALVE TO UPRIGHT POSITION.

SEE ATTACHED DRAWING.

1. I CLAIM AS MY INVENTION A FIREANT/INSECT GUN.
